(19) United States
(12) Patent Application Publication
(10) Pub. No.: US 2011/0119495 A1
(43) Pub. Date: May 19, 2011

(54) METHOD AND ARRANGEMENT RELATING TO ENCRYPTION/DECRYPTION OF A MEMORY UNIT

(75) Inventors: Kales Kahlid Daoud, Vastra Frolunda (SE); Peter Davin, Landvetter (SE); Anders Hansson, Goteborg (SE)

(73) Assignee: CRYPTZONE AB, Skara (SE)

(21) Appl. No.: 12/526,093

(22) PCT Filed: Feb. 6, 2009
(86) PCT No.: PCT/SE08/00106

§ 371 Date: Sep. 30, 2010

Related U.S. Application Data
(60) Provisional application No. 60/899,716, filed on Feb. 6, 2007.

(51) Int. Cl. G06F 21/00

(52) U.S. Cl. 713/183; 726/28

(57) ABSTRACT

A memory unit is disclosed comprising a security driver application providing an interface, a storage arrangement and a driver application for activation when connected to a memory accessing arrangement. The driver application is configured, when accessed, to authenticate a user using a password whereby the interface is configured to secure and/or unsecure data transactions to and from the storage arrangement.

### TECHNICAL FIELD

The present invention relates to a method and arrangement for encryption and/or decryption of contents of a memory unit, especially a memory unit detachably connected to a computer device, such as a personal computer.

### BACKGROUND OF THE INVENTION

Exchange of information, in particular privileged information between computers and users of the computers increases tremendously.

It is not unusual that the users, besides transmitting information, e.g. using e-mail applications, also store information on memory units detachable form computers. USB (Universal Serial Bus) memories have become very popular as they allow simple connection, fast and large storing ability, Former diskettes and disk-drives are more and more rare sight in the computers.

In a computer system, peripherals and other devices may be attached to a computer system by means of a bus, such as a USB bus, FireWire (IEEE 1394), Human Interface Devices (HID), PCMCIA, etc.

A computer system utilizing a USB bus will include a USB software layer that will interact with applications and mediate the sending and receipt of data from a central host to the peripherals.

The USB software layer supports generic USB hardware. The USB software layer is complex and flexible, in order to support the USB communication. The USB software layer preferably supports multiple independent hardware vendors' drivers and must remain pluggable. Therefore, the USB software layer may be changed often in order to respond to challenges such as changes in hardware or other updates. Moreover, there are a large number of different USB hardware elements available, and the USB software layer is preferably able to support this multiplicity of options.

Ordinary USB memories store data without any encryption, which allows easy access to the stored data, e.g. if the USB memory is lost.

Thus, there is a need for a way to provide the benefits of USB connectivity or any other similar memory type and compatibility with existing such devices and systems, while allowing for increased security.

### SUMMARY OF THE INVENTION

Advantages of the invention include:
Allowing user to secure/unsecure data to a memory unit
Deployed through the client based on policy settings
Encryption method controlled through policy setting
Centrally deployment control (not logging)
Recovery Password
Standalone application that doesn't require the client to function
Easy usability, wizard driven deployment
Event logging
Enforce encryption on everything placed on the memory unit

For these and other reasons described below a memory arrangement is provided comprising a security driver application providing an interface, a storage arrangement, and a driver application for activation when connected to a memory accessing arrangement. The driver application is configured to, when accessed, to authenticate a user using a password whereby said interface is configured to secure and/or unsecure data transactions to and from said storage arrangement, Preferably, the memory accessing arrangement comprises end-user processing commands used to access said data. The memory arrangement may be one of a USB (Universal Serial Bus) memory unit (memory stick), digital camera, digital video recorder, cell-phone and configured to be connected to a host being one or several of as a computer through a USB bus, FireWire (IEEE 1394), Human Interface Devices (HID), PCMCIA, Bluetooth or infrared. In one embodiment a client is configured to guide a user and function as a link between the user and the memory arrangement. The client may be a part of memory encryption policy, and applied to the user centrally. Preferably, a client deployment configuration comprises one of: securing memory arrangement manually, enquiring to secure memory arrangement once for each device, enquiring to secure memory arrangement every time an unsecured device is used.

The invention also relates to a method of policy based security deployment for a memory arrangement, using a first operation level, a second policy level and a third component logic level, whereby an administrator administrates said deployment policy of the second level, whereby the security deployment is transferred to said third level comprising, in which a server communicates with a client which is intended to receive said memory arrangement, and when said memory arrangement received, security policies are transferred to it and also provided to a user. Most preferably, when data is secured it is encrypted using suitable encrypting method. The method may further comprise a time lock feature used to lock the arrangement after a predetermined period. The method may comprise a recovery procedure operating as a secondary private password. The recovery password operates:
assigning an id to a key-slot that holds a key used to secure the arrangement,
storing a centrally administrated user id in a user profile data base,
using user's recovery password as a recovery seed,
providing a key used to encrypt said arrangement as a hash,
if the password is lost:
   authenticating the user and receiving a recovery data,
   using said recovery data and the user that is the owner of the recovery data used at the time of encryption,
   authenticating the user, and
   using the recovery password for un-securing a specific content,

In one embodiment the hash comprises a key identifier, user identifier and recovery seed combined. The recovery data may be the user identifier combined with the key identifier. A final recovery key is generated using: user identifier, key identifier and recovery seed.

### BRIEF DESCRIPTION OF THE DRAWINGS

In the following the invention is described with reference to a number of non-limiting exemplary embodiments illustrated schematically in the attached drawings, in which:

FIG. 1 is block diagram showing security levels according to the invention,

FIG. 2 is block diagram showing key handling according to the invention,

FIG. 3 is block diagram showing steps of generating recovery keys according to the invention,

FIG. 4 is block diagram handling recovery keys according to the invention,

FIG. 5 is block diagram showing request and response logic according to the invention,

FIG. 6 is a screen dump of logging information according to the invention, and

FIG. 7 is a block diagram showing a USB/computer according to the invention.

### DETAILED DESCRIPTION OF PREFERRED EMBODIMENTS

In the following, the invention is described with reference to a preferred example using a USB (Universal Serial Bus) memory unit (memory stick). However, it should be appreciated by a skilled person that teachings of the invention may be implemented on any type of memory units attachable to a computer, such memory units include memory sticks, digital cameras, digital video cameras, cell-phones, etc., which can be connected to a host such as a PC through a USB bus, FireWire (IEEE 1394), Human Interface Devices (HID), PCMCIA, Bluetooth, Infrared, etc.

The following describes the parameters involved when a user goes from having an unsecured memory unit to a secured memory unit. Basically the client is configured on how to guide the user in the deployment process. Once configured, the client works as a link between the user and the USB unit. This will be a part of the memory encryption Policy, and can be applied to the user centrally. The client deployment configuration is as follows:
Secure USB devices manually
Ask to secure an USB device once for each device
Ask to secure USB devices every time an unsecured device is inserted.

According to one embodiment, the USB memory can be configured for manual deployment, and the user will have to secure the USB device manually. A secondary option is in the settings, where the user may select ‘Secure USB device now’.

If configured for to be asked to secure an USB device once for each device, the client will prompt the user if he wants to secure an USB device as soon as he inserts the memory unit into his computer. It will only be done once for each device, since the client will keep track of the USB devices inserted.

If configured for to be asked each time an unsecured USB device is inserted, the client will prompt the user to secure the device each time he inserts it into his computer. This only occurs if the USB device is missing a secured area.

Preferably, the process of securing an USB device will be a wizard driven process. It aims to be as user friendly as possible.

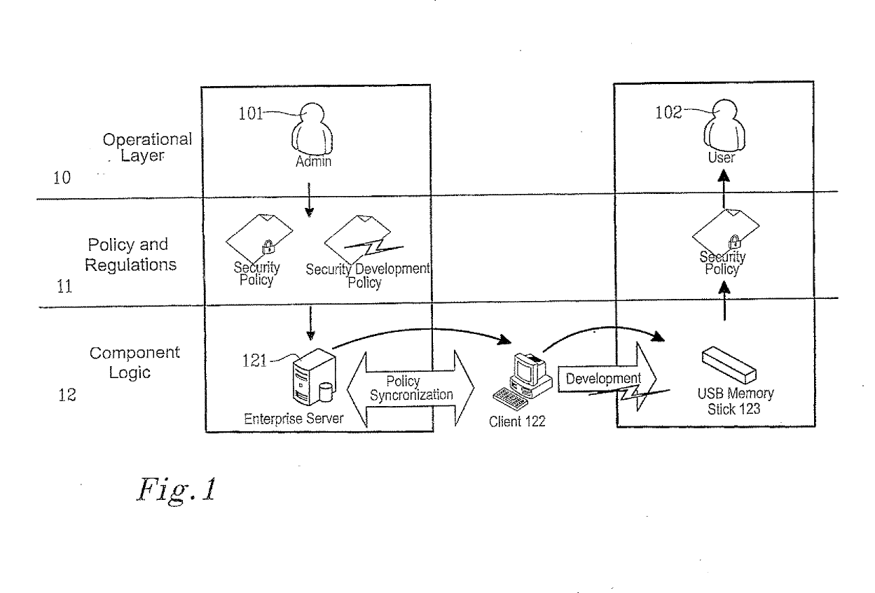

FIG. 1 illustrates policy based deployment procedure. The procedure comprises three levels: first operation layer 10, second policy and regulations 11 and third component logic 12. In operational layer 10, an administrator 101 administrates the security policy and security deployment policy of the second level. The security policy and policy deployment are transferred to level 3 comprising for example an enterprise server 121 (or a server intended for such functions). The enterprise server 121 communicates with a client 122 which is intended to receive a memory device 123. When memory unit 123 attached, security policies are transferred to it. The security policy is also provided to a user 102.

When securing data on the memory unit, different protection methods can be used, e.g. Secured Groups. This may be a part of the security policy, and can be applied to the user centrally.

Following protection methods may be available:
Recovery password
Master password
Private password
Custom password
Use Secured Groups
Ask for secured groups

However, when accessing the information, the user may have to enter a password manually each time he wants to access the information. The reason for this is that the memory unit logic does not have to hold any server connectivity logic or any connection to the users profile database on the client 122.

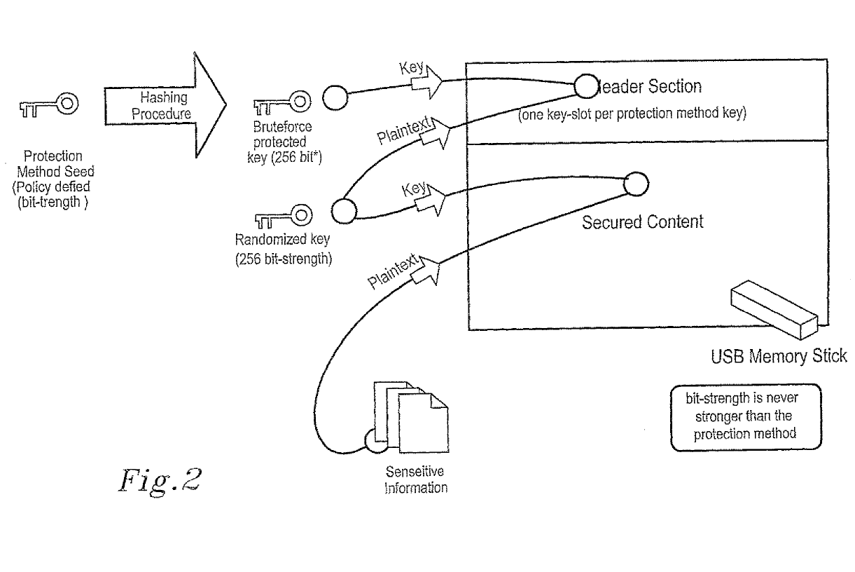

Technically, when data is secured it is encrypted, e.g. using AES256 with a strongly randomized 256 bit key or any other suitable encrypting algorithm. In this case, the key is placed in a “key-holder slots” in the secured data's header. Each key-slot is then encrypted using AES256 or any other suitable encrypting algorithm with the key related to a specific protection method. The key is a hashed version of the actual password, to prevent brute-force procedures. See FIG. 2.

A time lock feature may also be available for the memory unit, which is used to lock the device after a predetermined period.

The recovery password works as a secondary private password, and can be defined by a server. If the client is not configured towards a server, it will not be possible to secure data using a recovery password. Each secured entity will use different recovery passwords. Every user that resides on the server will have a recovery password generated for it.

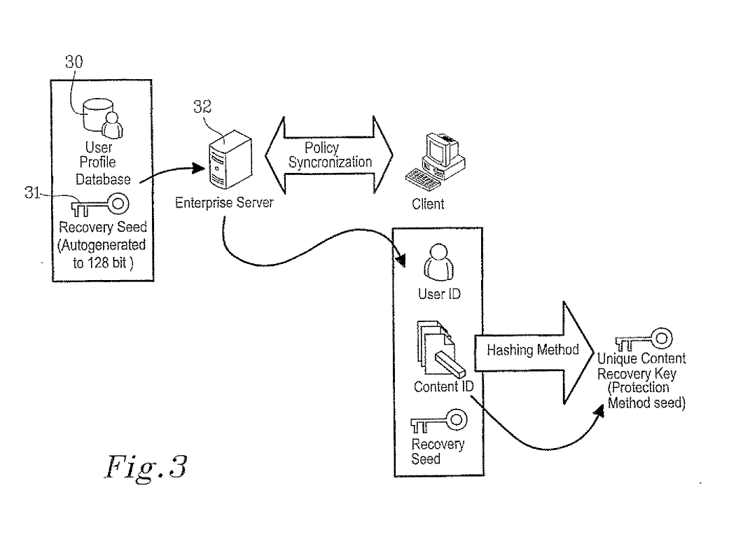

The recovery password operates in following way, see FIG. 3:
1. A file or USB device is secured. An id will be assigned to the key-slot that holds the key used to secure this entity. This ID is called the key identifier (in the figure marked as Content ID).
2. The Enterprise (centrally administrated) user ID is considered as user identifier, e.g. stored in user profile data base 30. The enterprise a general term comprising components such as the server, an administration tool and the client.
3. The user's recovery password (e.g. hosted by an enterprise server 32) is considered as recovery seed 31.
4. The key that will be used to encrypt the file or USB device will be a hash, for example, with the factors key identifier, user identifier and recovery seed combined.
5. if the password is lost:
6. Optionally, any user will receive information on how to contact a support in case of lost passwords, when he is trying to access the file. The user follows the instructions and contacts the support.
7. The support using an Admin tool goes through a “lost password & recovery password” routine.
8. Once authenticated, the user states a “recovery ticket”, which is the user identifier combined with the key identifier, e.g. separated by a character (such as “-”). The user will be able to see this information amongst the information on what to do if the password is lost. For example, the recovery ticket might be “3243-AA443210”—where 3243 is the user identifier, and AA443210 is the key identifier.
9. The support enters the recovery ticket in the admin tool wizard, and the user that is the owner of the recovery password used at the time of encryption is displayed.
10. The support authenticates (done verbally or in written form) the user calling in, and if they are satisfied with the authentication he or she clicks next.
11. The recovery password used for the specific content will be displayed at the support desks screen, whereas it is communicated to the user.

According to a preferred embodiment, there are three components to a recovery password:
User identifier: (e.g. 32 bits) ID of the user on the Enterprise Server
Key identifier: (e.g. 32 bits) ID of the key-slot that has the key to unlock the Secured File/Folder/USB device
Recovery seed: (e.g. 128 bits (variable)) The actual seed that will be generated and stored by the server.
Recovery ticket: A string value that is a concatenated string result of the user identifier and the key identifier (for example “00078-FEAB0002”).

The final recovery key is generated as follows:
SHA1 (user identifier ∥key identifier∥ recovery seed), which will result in, for example 160 bits of data.

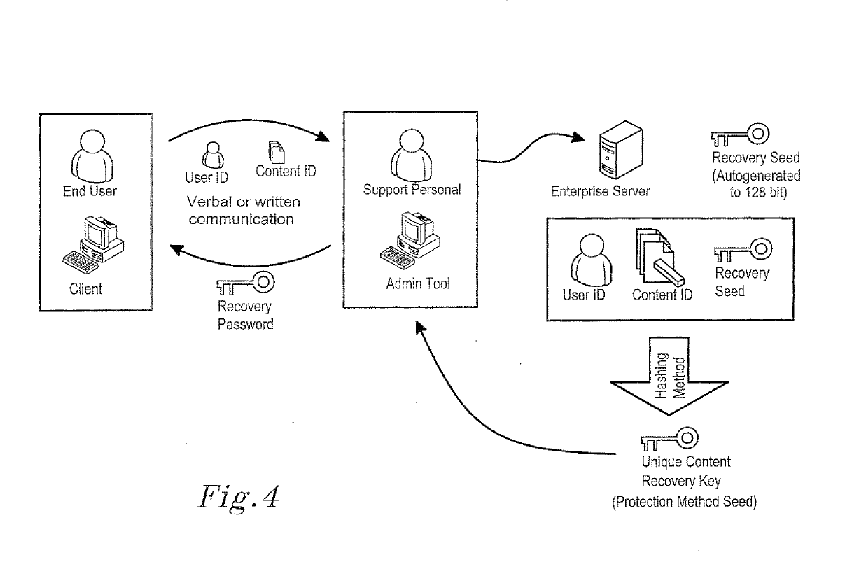

The recovery ticket will be encoded in a way so that it is user-readable and communicated easily in written or verbal form. See FIG. 4. When the server processes the recovery ticket, it will retrieve the id of the user (User identifier) and the key identifier. Using the user id, the server will retrieve the recovery seed used. The server will then process the user id, the key identifier and the recovery seed in the same way as mentioned above using, e.g. SHA1, to re-create the recovery password.

The USB memory is from a technical perspective the same as a folder in standalone executable mode placed on an USB Unit, i.e. the data on the memory is realised as folders and files which can be secured/encrypted, There is however one important difference—the memory unit's standalone execution can be written to. Every action performed with the secured area at the USB unit can be logged inside the secured area, see FIG. 5. This includes, deletion of files, un-securing files, securing files, changing password etc.

The logs are accessible for browsing if one has access to the secured area. It is done by opening the secured area in browser mode, going to the main menu and select Display Log-browser.

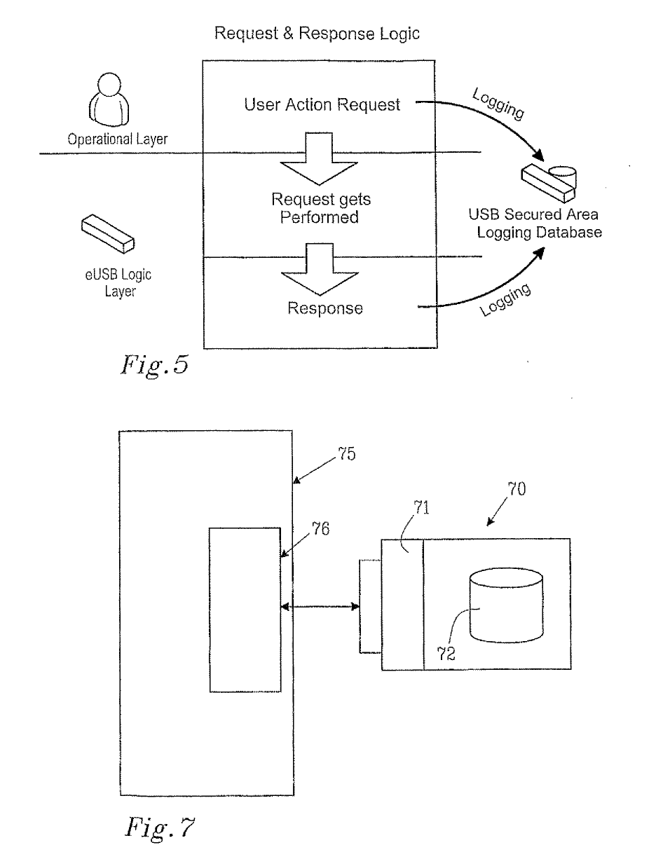

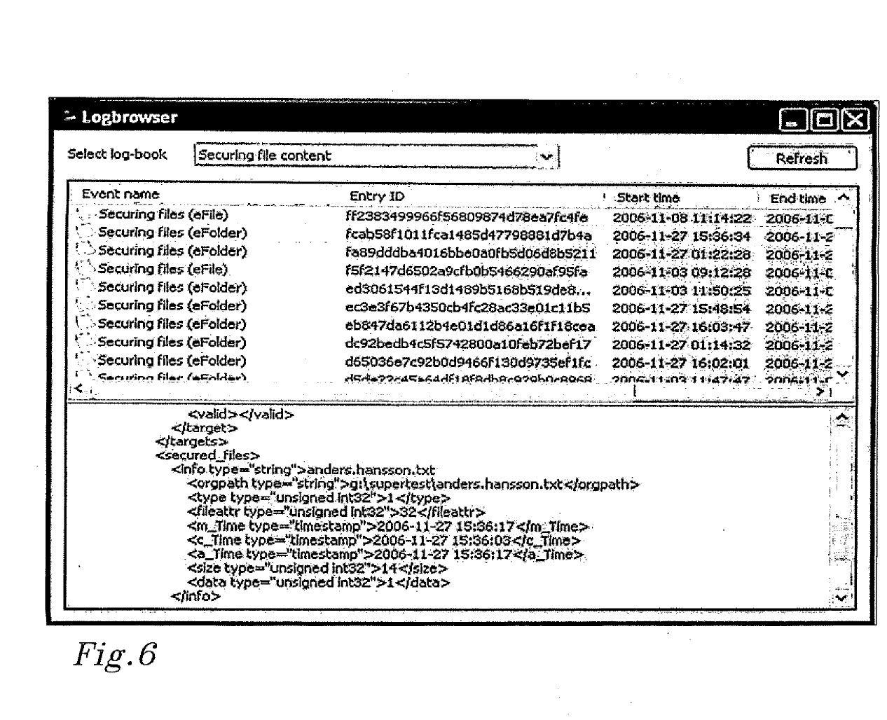

FIG. 6 is a screen shot of the Log browser for a client. The memory browser will look the same, but concerns logging USB related actions only.

The present invention allows enforce encryption on all data placed on the USB unit. The aim for this is to create a way so that data can not be stored as plain text on an USB unit that has a secured area, This feature can be policy controlled through settings:
Allow user to store unsecured data on the USB device
Automatically detect if unsecured data exists outside the secured area, and ask user to secure it.
Do not allow user to store unsecured data on the USB device

It is not necessary to create a policy only for USB unit or Master Password and apply it to all the users, A common usage scenario example is that there will be a policy created for, for example Mail security, one for USB security, and one for Master Password. The Master Password may override other passwords and managed by an administrator. The Master Password policy will be applied to the root of the tree so that every user will have the same and only users who will use USB will get the USB policy. This adds great flexibility to the product and gives the administrators the chance to configure the policy settings in the way they want.

Going hand in hand with the previous feature, a user is allowed to have multiple policies instead of a single one. For example the user might have 3 policies, one for USB, one for files on a computer and one for Master Password, instead of having only one policy with everything in it.

The administrator will have the possibility to choose a “list” of policies for the users and rank each policy in the list. The higher rank a policy has means it will override the policies with a lower rank. This is only the case when the two policies have settings that conflict with each other.

### EXAMPLE

Policy A has some settings defined for email securing and file securing. Policy B has some settings defined for email securing, Password and Admin Lock. User is applied both Policy A and Policy B, with Policy A as higher rank. The user will get the settings for email from Policy A since it has higher rank than policy B. However, he will get Password and Admin Lock settings from policy B since these settings have not been defined in pined in policy A.

FIG. 7 illustrates the encryption procedure for the USB memory 70 according to the invention. The USB memory comprises a security driver application 71 and a database located in the flash memory location 72. The driver application 76, when connected to a computer 75 is activated. Once the driver application 71 is accessed, it will authenticate the user using a password prompt. The end-user processing commands on the computer 75 using the interface provided by the driver application 71 will then be able to secure and unsecure data to and from the USB device. The secured data is stored in the USB memory driver location 72.

1. A memory arrangement comprising a security driver application providing an interface, a storage arrangement, and a driver application for activation when connected to a memory accessing arrangement, said driver application being configured, when accessed, to authenticate a user using a password whereby said interface is configured to secure and/or unsecure data transactions to and from said storage arrangement.

2. The memory arrangement of claim 1, wherein said memory accessing arrangement comprises end-user processing commands for accessing said data.

3. The memory arrangement of claim 1, wherein said memory arrangement is selected from the group consisting of a USB (Universal Serial Bus) memory unit (memory stick), digital camera, digital video recorder, and a cell-phone.

4. The memory arrangement of claim 1, configured to be connected to a host selected from the group consisting of a computer through a USB bus, a FireWire (IEEE 1394), Human Interface Device (HID), a PCMCIA, Bluetooth, Infrared, or combinations thereof.

5. The memory arrangement of claim 1, including the use of a client configured to guide a user and to function as a link between the user and the memory arrangement.

6. The memory arrangement of claim 6, wherein said client is part of a memory encryption policy, and is applied to the user centrally.

7. The memory arrangement of claim 1, including a client deployment configuration selected from the group consisting of securing a memory arrangement manually, enquiring to secure a memory arrangement once for each device, and enquiring to secure a memory arrangement every time an unsecured device is used.

8. A method of policy based security deployment for a memory arrangement, using a first operation level, a second policy level and a third component logic level, said method comprising administrating said deployment policy of the second level, whereby the security deployment is transferred to said third level comprising, a server communicating with a client which is intended to receive said memory arrangement, and when said memory arrangement is received, security policies are transferred to it and also provided to a user.

9. The method of claim 8, including securing data including encrypting said data using a suitable encrypting method.

10. The method of claim 8, further comprising utilizing a time lock feature to lock the arrangement after a predetermined period.

11. The method of claim 8, comprising utilizing a recovery procedure to operate as a secondary private password.

12. The method of claim 11, wherein said recovery password operates by:
assigning an id to a key-slot that holds a key used to secure the arrangement,
storing a centrally administrated user id in a user profile data base,
using a user's recovery password as a recovery seed,
providing a key used to encrypt said arrangement as a hash,
and, if the password is lost:
authenticating the user and receiving recovery data,
using said recovery data and the user that is the owner of the recovery data at the time of encryption,
authenticating the user, and
using the recovery password for un-securing a specific content.

13. The method of claim 12, wherein said hash comprises a key identifier, user identifier and recovery seed combined.

14. The method of claim 13, wherein said recovery data is the user identifier combined with the key identifier.

15. The method of claim 14, wherein a final recovery key is generated using: user identifier, key identifier and recovery seed.
